(19) United States
(12) Patent Application Publication
(10) Pub. No.: US 2007/0296194 A1
(43) Pub. Date: Dec. 27, 2007

(54) Closeout apparatus for an adjustable steering column assembly

(76) Inventors: Jason R. Ridgway, Bay City, MI (US); Ronald H. Dybalski, Oxford, MI (US)

Correspondence Address: DELPHI TECHNOLOGIES, INC., M/C 480-410-202, PO BOX 5052, TROY, MI, 48007, US

(21) Appl. No.: 11/638,045

(22) Filed: Dec. 13, 2006

Related U.S. Application Data
(60) Provisional application No. 60/805,377, filed on Jun. 21, 2006.

(51) Int. Cl. B62D 1/18; B60K 37/00

(52) U.S. Cl. 280/775; 74/493; 180/90

(57) ABSTRACT

A closeout apparatus is disclosed for a vehicle having an instrument panel defining a cavity. A steering column is disposed within the cavity, with a steering wheel coupled to the steering column. The steering column adjusts between extended and retracted positions. A cover having an apron is mounted about the cavity. A flange extends from the apron and surrounds part of the steering column. A shroud is mounted adjacent to the steering wheel and surrounds portions of both the flange and the steering column. The shroud cooperates with the flange to conceal a gap formed between the cover and the steering wheel. The flange includes upper and lower portions, each having a substantially equal predetermined length. The shroud continuously surrounds a portion of the flange and is spaced laterally from the cover to continuously conceal the gap during adjustment of the steering column between the extended and retracted positions.

### CROSS REFERENCE TO RELATED APPLICATION

The subject patent application claims priority to and all the benefits of U.S. Provisional Patent Application No. 60/805,377, which was filed on Jun. 21, 2006.

### BACKGROUND OF THE INVENTION

1. Field of the Invention

The subject invention relates to an instrument panel closeout for a vehicle. More particularly, the invention relates to an improved instrument panel closeout that covers a gap between an adjustable steering column and the instrument panel.

2. Description of the Prior Art

Steering columns for motor vehicles are often designed for adjustable positioning of a steering wheel for improved driver comfort. Such steering columns commonly provide the driver with an adjustable rake or tilt which allows angular adjustment of the steering wheel in up and down directions. The steering column may also include a telescoping or extension adjustment for allowing the steering wheel to be moved closer to or farther away from the driver. Motor vehicle instrument panels include a cavity through which the steering column passes and the cavity is large enough to accommodate the full range of motion of the steering column. As a result, the cavity size and the exposure of the steering column to the driver is unacceptable for both quality and aesthetic purposes.

To cover the steering column a shroud is attached to the steering wheel which extends toward the cavity. The shroud moves with the steering wheel relative to the cavity based on the raking and telescoping movements of the steering column However, when the steering column telescopes the shroud alone cannot completely hide the steering column or the cavity as the shroud is fixed as to both length and size thereby leaving portions of the steering column and the cavity exposed and visible.

Efforts have been made to cover gaps between the shroud and the instrument panel at all positions in the range of motion of the steering column relative to the instrument panel. For example, a flexible rubber gusset has been attached between the instrument panel and the shroud, with respective ends of the gusset fixed to the instrument panel and the shroud. The gusset deforms as necessary during movement of the steering column. However, the gussets often squeak and make excessive noise during movement of the steering column, which is undesirable. Further, the gussets often appear wrinkled and deformed after movement of the steering column, which is also undesirable. In addition, a tradeoff between durability and flexibility is required in order to accommodate the range of motion required by today's manufacturers.

As an alternative to the flexible rubber gusset, a leather boot has been attached adjacent an opening of the shroud and is moveable relative to the instrument panel. Although the leather boot may reduce the size of the gap between the instrument panel and the shroud, the steering column must still retain its full range of motion, which still results in unacceptably large gaps at various points in the range of motion of the steering column.

Accordingly, there exists a need for an improved instrument panel closeout that sufficiently covers the gap between the steering column and the instrument panel at all positions of the steering column relative to the instrument panel while allowing for a full range of adjustment.

### SUMMARY OF THE INVENTION AND ADVANTAGES

The subject invention discloses an adjustable steering column assembly for a vehicle. The vehicle includes an instrument panel with the instrument panel defining a cavity. The assembly comprises a steering column defining a longitudinal axis disposed within the cavity of the instrument panel. The steering column is longitudinally adjustable along the longitudinal axis between an extended position and a retracted position, and is angularly adjustable relative to the longitudinal axis between an up position and a down position. A steering wheel is coupled to the steering column. A cover having an apron is mounted to the instrument panel about the cavity. The cover includes a flange that extends from the apron to surround a portion of the steering column. The flange defines a gap between the flange and the steering wheel. A shroud is mounted adjacent to the steering wheel. The shroud surrounds a portion of the steering column and also surrounds a portion of the flange of the cover. The flange cooperates with the shroud to conceal the gap between the flange and the steering wheel. The flange has an upper portion and a lower portion with each of the portions having a predetermined length along the longitudinal axis at least equal to a length of the adjustment between the extended and retracted positions. The shroud continuously surrounds a portion of the flange, and is spaced laterally from the flange during the adjustment between the extended and retracted positions and the up and down positions such that the shroud continuously conceals the gap between the flange and the steering wheel without engaging the flange.

Accordingly, the subject invention provides an improved adjustable steering column assembly that addresses the various problems found in the prior art. The instrument panel closeout of the subject invention allows for a full range of adjustment while sufficiently covering the gap between the steering column and the instrument panel at all positions of adjustment.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an automotive interior having an adjustable steering column assembly;

FIG. 2 is a perspective view of a cavity in an automotive instrument panel;

FIG. 3 is a perspective view of a cover installed about the cavity of an automotive instrument panel;

FIG. 4 is a partially cross-sectional side view of the adjustable steering column assembly having a steering wheel;

FIG. 5 is a partially cross-sectional side view of an alternate embodiment of the adjustable steering column assembly having a steering wheel;

FIG. 6 is a partially cross-sectional side view of the adjustable steering column assembly in a fully retracted and tilted up position;

FIG. 7 is a partially cross-sectional side view of the adjustable steering column assembly in a fully retracted and tilted down position;

FIG. 8 is an enlarged perspective view of the adjustable steering column in the fully retracted position;

FIG. 9 is a partially cross-sectional side view of the adjustable steering column assembly in a fully extended and tilted up position;

FIG. 10 is a partially cross-sectional side view of the adjustable steering column in a fully extended and tilted down position; and

FIG. 11 is a perspective view of the adjustable steering column in a fully extended position.

### DETAILED DESCRIPTION OF THE INVENTION

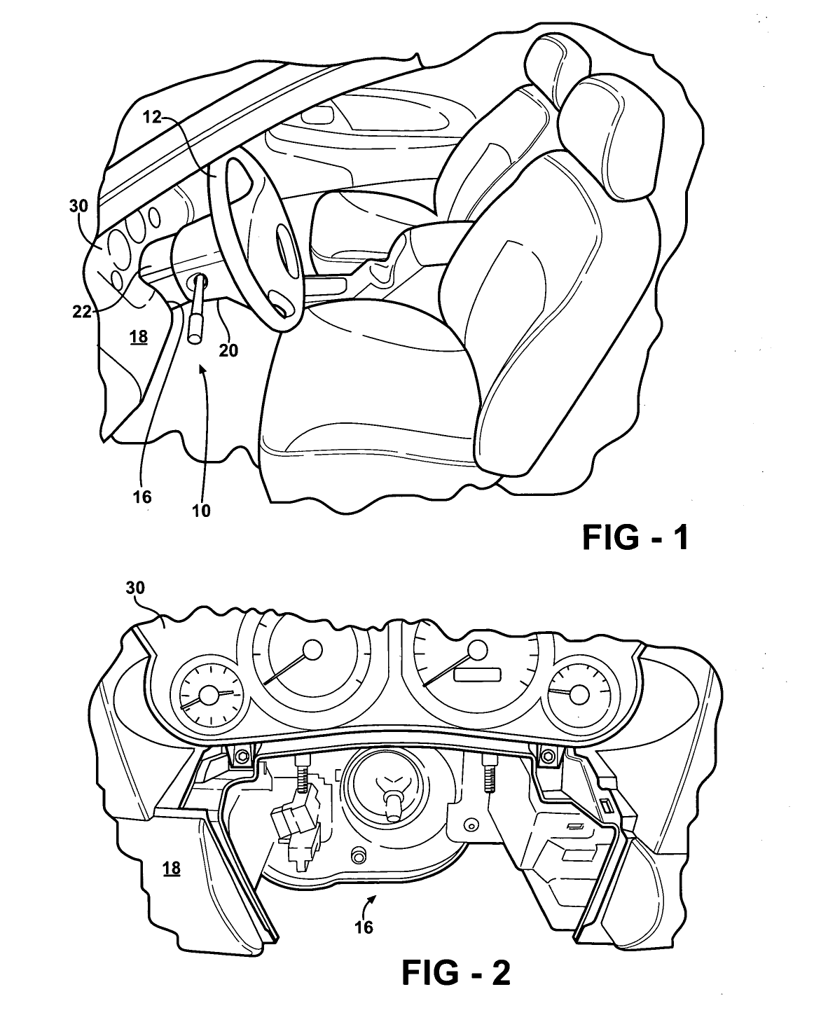

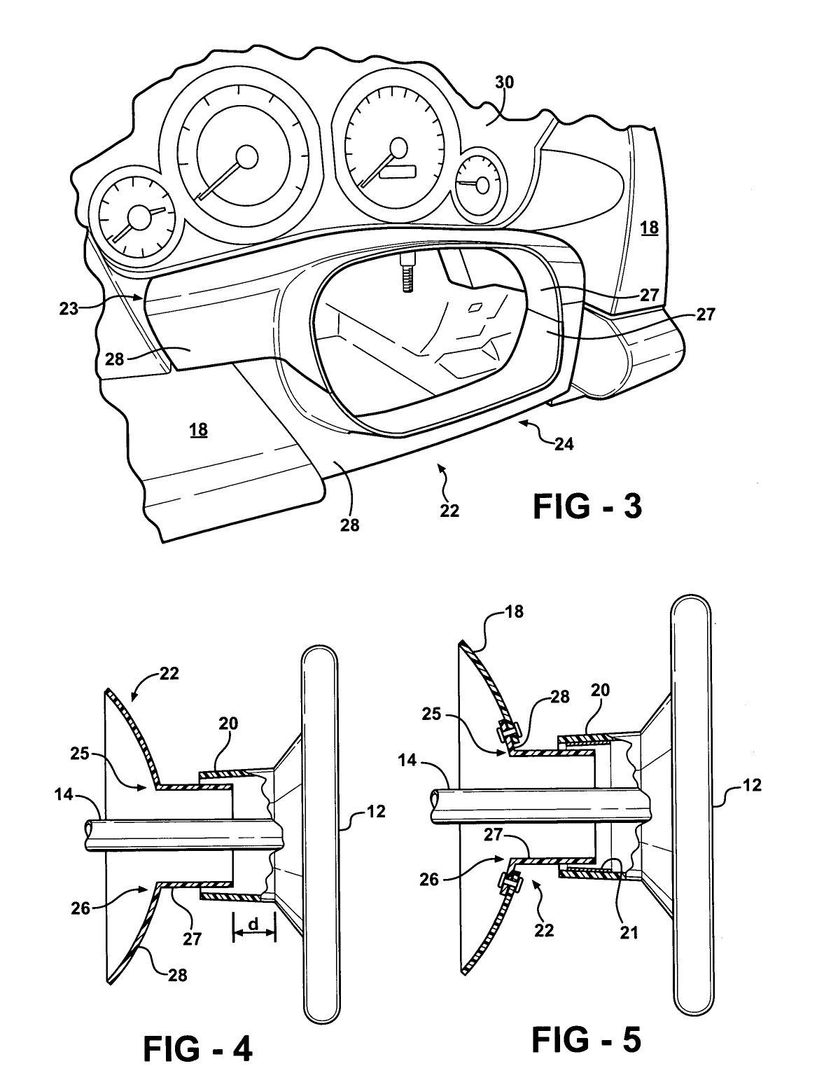

Referring to the Figures, wherein like numerals indicate corresponding parts throughout the several views, an adjustable steering column assembly is shown generally at 10 in FIG. 1. Referring to FIGS. 1 and 2, the steering column assembly 10 is for a vehicle having an instrument panel 18. The instrument panel 18 includes an instrument cluster 30 and defines a cavity 16. Typically, the cavity 16 is disposed below the instrument cluster 30.

Referring to FIGS. 4 through 7 and 9 through 10, a steering column 14 is disposed within and extends through the cavity 16 of the instrument panel 18, and defines a longitudinal axis. The steering column 14 is adjustable along the longitudinal axis between an extended position (shown in FIG. 11) and a retracted position (shown in FIG. 8), and is angularly adjustable relative to the longitudinal axis between an up position and a down position. The steering column 14 includes an outer jacket mounted to the vehicle and supports an inner jacket. A shaft is rotatably supported within the inner jacket as is well known in the art. A steering wheel 12 is coupled to the shaft of the steering column 14 as is also well known in the art.

The steering column assembly 10 includes a closeout apparatus for concealing the steering column 14 disposed between the instrument panel 18 and the steering wheel 12. The closeout apparatus includes a cover 22 having an apron 28 for mounting the cover 22 to the instrument panel 18. The cover 22 is mounted about the cavity 16 of the instrument panel 18. The cover 22 may be mounted to the instrument panel 18 with any of a variety of mounting techniques, such as with an adhesive, by mechanical fasteners, or some other suitable mounting technique. A flange 27 extends from the apron 28 along the longitudinal axis and surrounds a portion of the steering column 14. The flange 27 extends from the apron 28 to a distal end, and defines a gap d between the distal end of the flange 27 and the steering wheel 12. As shown in FIG. 4, the flange 27 may be integrally formed with the apron 28. Alternately, as shown in FIG. 5, the flange 27 may be separately mounted to the apron 28. Preferably, the apron 28 is formed of a sufficiently rigid material in order to provide adequate support for itself. However, it should be understood that the rigid material of the apron 28 is flexible enough to the steering column 14 collapses during a collision of the vehicle.

The closeout apparatus further includes a shroud 20 mounted adjacent to the steering wheel 12. The shroud 20 may be mounted to the steering wheel 12 with any of a variety of mounting techniques, such as with an adhesive, with mechanical fasteners, or some other suitable mounting technique. The shroud 20 surrounds a portion of the flange 27 of the cover 22 and also surrounds a portion of the steering column 14. The shroud 20 cooperates with the flange 27 to conceal the gap d between the distal end of the flange 27 and the steering wheel 12.

As shown in FIG. 5, the steering column assembly 10 may include a noise dampening material 21 disposed on the shroud 20 for improving the acoustic properties of the steering column assembly 10. In a preferred embodiment, the noise dampening material 21 is disposed on an inner surface of the shroud 20 to hide the noise dampening material 21 from view. As shown, the noise dampening material 21 is disposed axially on the shroud 20 between the shroud 20 and the apron 28. It should be understood that the noise dampening material 21 may also be disposed on the inner surface of the shroud 20 not adjacent the apron 28. As another alternative embodiment, the noise dampening material 21 could be disposed on an outer surface of the flange 27. Preferably, the noise dampening material 21 may be of a material such as foam or felt. However, it should be understood that the noise dampening material 21 may be formed from some other suitable acoustic dampening material.

The flange 27 includes an upper portion 25 and a lower portion 26. Each of the upper portion 25 and the lower portion 26 has a predetermined length along the longitudinal axis at least equal to a length of the adjustment between the extended position and the retracted position. The shroud 20 continuously surrounds a portion of the flange 27 and is spaced laterally from the flange 27 during the adjustment between the extended position and the retracted position and the up position and the down position for continuously concealing the gap d between the flange 27 and the steering column 14 without engaging the flange 27. In other words, the shroud 20 does not contact the flange 27, regardless of the position of the steering column 14 and the steering wheel 12.

The predetermined lengths of the upper portion 25 and the lower portion 26 of the flange 27 are substantially equal, and are greater than the length of the adjustment between the extended position and the retracted position. Preferably, the predetermined lengths are at least 50 mm. However, the predetermined lengths may also be at least 60 mm, and it should be understood that the predetermined length may include some other length not specifically enumerated herein.

Preferably, the shroud 20 and the cover 22 are formed of a polymeric material. However, it should be understood that the shroud 20 and the cover 22 may be formed from some other suitable material.

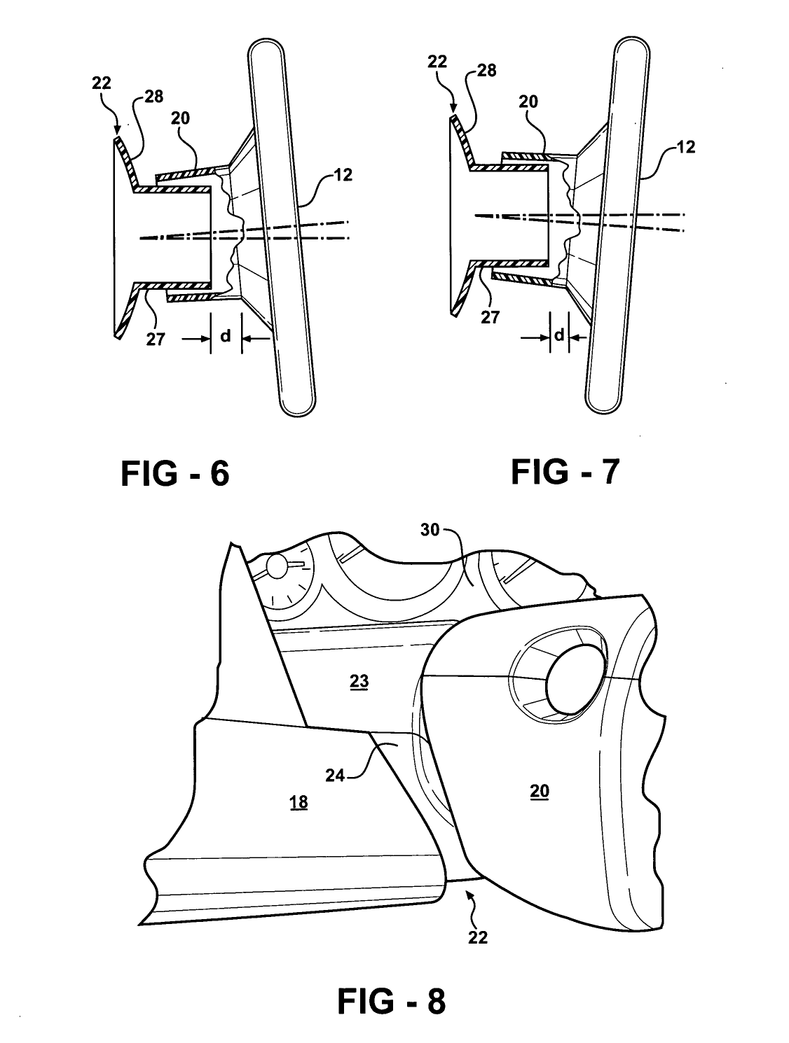

FIGS. 6 and 7 show the relationship of the shroud 20 and the flange 27 when the steering wheel 12 is at minimum extension. Referring to FIG. 6, the shroud 20 is shown overlapping the flange 27 when the steering wheel 12 is at full up tilt and at minimum extension, i.e., in the retracted position. FIG. 7 shows the shroud 20 overlapping the flange 27 when the steering wheel 12 is fully tilted down and at minimum extension. FIG. 8 shows how the steering column 14 is fully covered by the shroud 20 and the cover 22 when the steering wheel 12 is in the retracted position

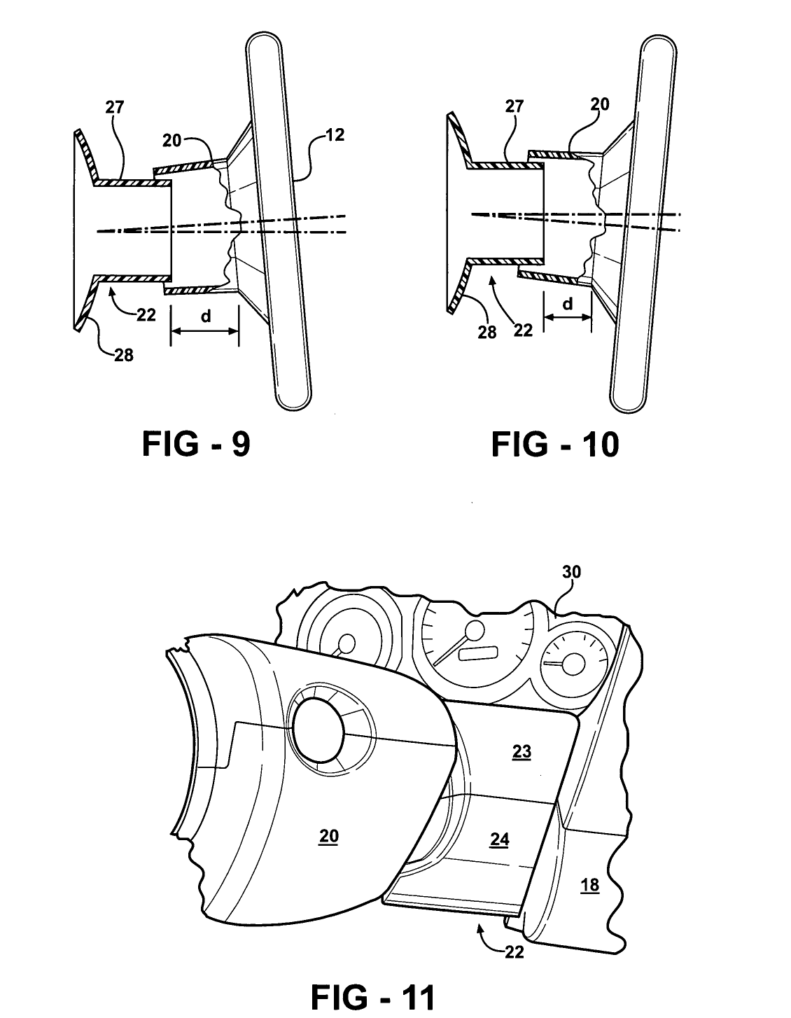

FIGS. 9 and 10 show the relationship of the shroud 20 and the flange 27 when the steering wheel 12 is at maximum extension. In FIG. 9 the shroud 20 is shown overlapping the flange 27 when the steering wheel 12 is at full up tilt and at maximum extension. Referring to FIG. 10, the shroud 20 is shown overlapping the flange 27 when the steering wheel 12 is at full down tilt and at maximum extension. FIG. 11 shows how the steering column 14 is fully covered by the shroud 20 and the cover 22 provide when the steering wheel 12 is in the extended position.

In the embodiment shown in FIGS. 8 and 11, the cover 22 includes an upper piece 23 and a lower piece 24 with the upper piece 23 defining the upper portion 25 of the flange 27 and the lower piece 24 defining the lower portion 26 of the flange 27. The upper piece 23 and the lower piece 24 are dimensionally similar with each of the pieces 23, 24 covering substantially half of the cavity 16. The shroud 20 also includes two pieces with each of the two pieces surrounding a portion of the flange 27. However, it should be understood that the shroud 20 and the cover 22 may each be unitary pieces, i.e., the shroud 20 is a unitary piece and the cover 22 is a unitary piece, and the scope of the invention should not be limited to require the shroud 20 and the cover 22 to include separate pieces.

The foregoing invention has been described in accordance with the relevant legal standards; thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. An adjustable steering column assembly for a vehicle having an instrument panel with the instrument panel defining a cavity, said assembly comprising;
a steering column defining a longitudinal axis for disposition within the cavity of the instrument panel and longitudinally adjustable along said longitudinal axis between an extended position and a retracted position and angularly adjustable relative to said longitudinal axis between an up position and a down position,
a steering wheel coupled to said steering column,
a cover having an apron for mounting to the instrument panel about the cavity and a flange extending from said apron for surrounding a portion of said steering column and defining a gap between said flange and said steering wheel, and
a shroud mounted adjacent said steering wheel and surrounding a portion of said flange of said cover and a portion of said steering column for cooperating with said flange to conceal said gap between said flange and said steering wheel,
said flange having an upper portion and a lower portion with each of said portions having a predetermined length along said longitudinal axis at least equal to a length of said adjustment between said extended and retracted positions with said shroud continuously surrounding a portion of said flange and spaced laterally from said flange during said adjustment between said extended and retracted positions and said up and said down positions for continuously concealing said gap between said flange and said steering wheel without engaging said flange.

2. An assembly as set forth in claim 1 wherein said predetermined lengths of said upper and lower portions of said flange are substantially equal.

3. An assembly as set forth in claim 1 wherein said predetermined lengths are at least 50 mm.

4. An assembly as set forth in claim 1 wherein said predetermined lengths are at least 60 mm.

5. An assembly as set forth in claim 1 wherein said predetermined lengths are greater than said length of said adjustment between said extended and retracted positions.

6. An assembly as set forth in claim 1 wherein said cover includes an upper piece and a lower piece with said upper piece defining said upper portion of said flange and said lower piece defining said lower portion of said flange.

7. An assembly as set forth in claim 6 wherein said upper piece and said lower piece are dimensionally similar with each of said pieces covering substantially half of the cavity.

8. An assembly as set forth in claim 1 wherein said shroud includes two pieces with each of said two pieces surrounding a portion of said flange.

9. An assembly as set forth in claim 1 wherein said shroud and said cover are formed of a polymeric material.

10. An assembly as set forth in claim 1 further including a noise dampening material disposed on said shroud.

11. A closeout apparatus for a vehicle having an instrument panel defining a cavity, a steering column, and a steering wheel coupled to the steering column, the steering column disposed within the cavity and being adjustable between an extended position and a retracted position along a longitudinal axis, said apparatus comprising;
a cover having an apron for mounting to the instrument panel about the cavity and a flange extending from said apron for surrounding a portion of the steering column, and
a shroud adapted for mounting adjacent the steering wheel with said shroud surrounding a portion of said flange of said cover and a portion of the steering column and cooperating with said flange to conceal a gap formed between said flange and the steering wheel,
said flange having an upper portion and a lower portion with each of said portions having a predetermined length along the longitudinal axis that are substantially equal with said shroud continuously surrounding a portion of said flange and spaced laterally from said flange for continuously concealing the gap during adjustment of the steering column between the extended and retracted positions.

12. An apparatus as set forth in claim 11 wherein said predetermined lengths are at least 50 mm.

13. An apparatus as set forth in claim 11 wherein said predetermined lengths are at least 60 mm.

14. An apparatus as set forth in claim 11 wherein said cover includes an upper piece and a lower piece with said upper piece defining said upper portion of said flange and said lower piece defining said lower portion of said flange.

15. An assembly as set forth in claim 14 wherein said upper piece and said lower piece are dimensionally similar with each of said pieces covering substantially half of the cavity.

16. An assembly as set forth in claim 11 wherein said shroud includes two pieces with each of said two pieces surrounding a portion of said flange.

17. An assembly as set forth in claim 11 wherein said shroud and said cover are formed of a polymeric material.

18. An assembly as set forth in claim 11 further including a noise dampening material disposed on said shroud.
